(19) United States
(12) Patent Application Publication
(10) Pub. No.: US 2016/0011675 A1
(43) Pub. Date: Jan. 14, 2016

(54) Absolute Position 3D Pointing using Light Tracking and Relative Position Detection

(71) Applicant: AMCHAEL VISUAL TECHNOLOGY CORPORATION, Hsinchu (TW)

(72) Inventors: Kai Michael Cheng, Hsinchu (TW); Yushiuan Tsai, Guishan Township (TW)

(21) Appl. No.: 14/627,738

(22) Filed: Feb. 20, 2015

Related U.S. Application Data
(60) Provisional application No. 61/942,605, filed on Feb. 20, 2014.

(51) Int. Cl. G06F 3/0346; G06T 7/20; G06F 3/042; G06T 7/00; G06F 3/03; G06F 3/038

(52) U.S. Cl. CPC G06F 3/0346; G06F 3/0304; G06F 3/0386; G06F 3/0421; G06T 7/0044; G06T 7/20; G06F 2203/04101; G06T 2200/24

(57) ABSTRACT

A computing system for direct three-dimensional pointing includes at least one computing device, and a pointing/input device including at least one light source and a motion sensor module for determining absolute and relative displacement of the pointing/input device. At least one imaging device is configured for capturing a plurality of image frames each including a view of the light source as the pointing/input device is held and/or moved in a three-dimensional space. A computer program product calculates at least a position and/or a motion of the light source in three-dimensional space from the plurality of sequential image frames and from the pointing/input device absolute and relative displacement information, and renders on the graphical user interface a visual indicator corresponding to the calculated position and/or the motion of the light source.

This utility patent application claims the benefit of priority in U.S. Provisional Patent Application Ser. No. 61/942,605 filed on Feb. 20, 2014, the entirety of the disclosure of which is incorporated herein by reference.

### TECHNICAL FIELD

The present disclosure relates to human-computer interaction systems. More specifically, the disclosure relates to methods and systems directed to three-dimensional pointing, using a system allowing determination of an absolute location on an image display apparatus using both active and passive devices.

### SUMMARY

The present invention reveals how a user can get an absolute location on an image display apparatus using a system integrated with both active and passive devices. The system consists of a pointing device called Absolute Pointer 22, an image display apparatus 30 (e.g., a projector, a TV, a monitor, etc.), an image capture device 2 (e.g., a webcam), and a computer 4. A transferring protocol, which can be wired or wireless, is adopted between the image capture device 2 and the computer 4 (Error! Reference source not found.).

The Absolute Pointer 22 functions as an infrared pointer, except it moves a cursor instead of a red spot. When an operator O uses Absolute Pointer 22 to aim at a point (e.g., point 6) on the image display apparatus 30, a cursor will appear at the location pointed to by the Absolute Pointer 22. This cursor will move when the Absolute Pointer 22 is moved, but always to a location pointed to by the Absolute Pointer 22 on the image display apparatus 30.

The Absolute Pointer 22 can also be used as a mouse-like input device. The position specified by the Absolute Pointer 22 is acquired through a computation process by the computer, and coordinates of the specified position can be used to identify an item or icon on the screen of the computer. Therefore, by manipulating the Absolute Pointer 22, a user can interact with most operating systems (e.g., Android® or Microsoft® Windows®), such as select files, programs, or actions from lists, groups of icons, etc., and can freely move files, programs, etc., issue commands or perform specific actions, such as we do in a drawing program.

### BRIEF DESCRIPTION OF THE DRAWINGS

FIG. 1 shows an image display apparatus according to the present disclosure for use in a system integrated with both active and passive devices;

FIG. 2 shows a pointing device according to the present disclosure;

FIG. 3 depicts calculation of an absolute position of a pointer according to the present disclosure;

FIG. 4 depicts a mathematical model for perspective projection to compute x- and y-coordinates in a world coordinate system according to the present disclosure;

FIG. 5 depicts the calibration step 508 of FIG. 3;

FIG. 6 depicts attempting a determination of positions P on an image display apparatus using only a motion vector and a projection point;

FIG. 7 depicts a calculation of a new position P′ using a three-axis relative positioning subsystem;

FIG. 8 depicts a direct calculation of a new position P′ using a three-axis relative positioning subsystem; and

FIG. 9 shows a system integrated for use with both active and passive devices for calculating an absolute position of a pointer on an image display apparatus according to the present disclosure.

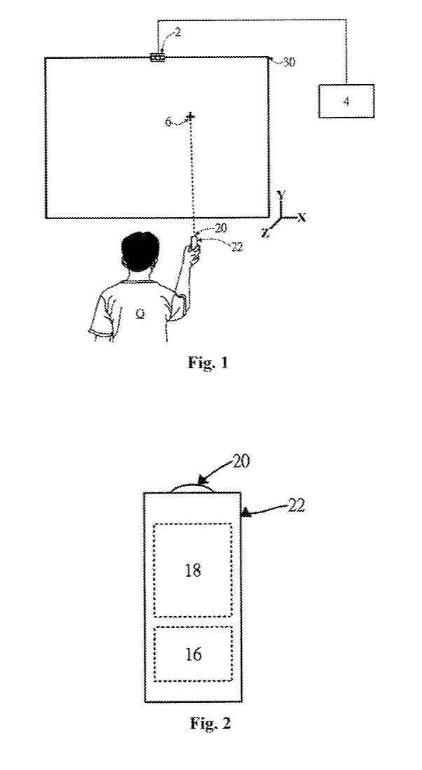

### DETAILED DESCRIPTION

Three components are embedded in the Absolute Pointer 22: a LED light source 20 (at the front end), a control panel 18, and a relative positioning subsystem 16 (FIG. 2). The system uses images of the LED 20 taken by the image capture device 2 and information provided by the relative positioning subsystem 16 to identify the location pointed to by the Absolute Pointer 22. An absolute position on the image display apparatus 30 can then be precisely computed.

The front LED light source 20 is used as an indicator of the location of a cursor by the system.

The control panel 18 consists of multiple buttons, which can provide direct functionality, such as the number keys, arrow keys, enter button, power button, etc.

The relative positioning subsystem 16 consists of a set of relative motion detecting sensors to provide relative motion information of the device (e.g., acceleration, rotations, etc) to the computer in real time through some wireless channel. The set of relative motion detecting sensors contained in the relative positioning subsystem 16 can include a g-sensor, a gyroscope sensor and so on.

The image capture device 2 functions as a viewing device for the computer. It takes images of the scene in front of the image display apparatus at a fixed frame rate per second and sends the images to the computer for subsequent processing. Most of the conventional single lens imaging devices, such as a standard webcam, can be used as a image capture device for the system. However, to provide a steady performance, the image capture device should have a frame rate that is at least 30 frames per second.

The computer 4 provides the functionality of light source location recognition that will recognize the location of the LED light source 20 in the image sent by the image capture device 2, and then converts the LED light source 20 location in the image to a point (e.g., point 6) on the image display apparatus 30. When the computer 4 receives an image from the image capture device 2, it first identifies the location of the LED light source 20 in the image using image recognition techniques, it then finds x- and y-coordinates of the LED light source location in the image with respect to the origin of the coordinate system of the image. In the meanwhile, using a tilt vector provided by the relative positioning subsystem 16, the computer 4 can compute the distance between the Absolute Pointer 22 and the image display apparatus 30. The x- and y-coordinates of the LED light source location in the image are then used with the distance between the Absolute Pointer 22 and the image display apparatus 30 to determine the location of a cursor in the x-y coordinate system of the image display apparatus 30. Therefore, by moving the Absolute Pointer around in front of the image display apparatus 30, one can determine the location of a cursor on the image display apparatus 30 through the LED light at the front end of the Absolute Pointer 22.

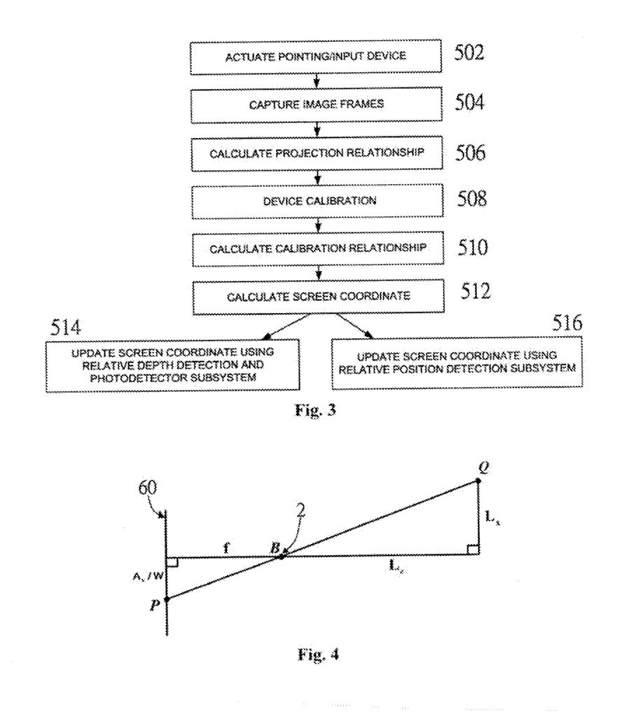

The calculation process of the system is shown in FIG. 3. In Step 502, the operator O powers on the Absolute Pointer 22, and allows the computer 4 to start with the LED light recognition process through images taken by the image capture device 2. In Step 504, the image capture device 2 starts capturing images while the computer 4 starts recognizing the location of the LED light source 20 in the images and records the coordinates of the LED light source in the images. In Step 506, coordinates of the recognized LED light source in the images recorded from the previous step (Step 504) are put into a mathematical model for perspective projection to compute x- and y-coordinates in the world coordinate system (FIG. 4). In Step 508, the operator O aims the Absolute Pointer 22 at some specific point (e.g., the upper left corner 30A) on the image display apparatus 30, while the computer records the tilt data of the Absolute Pointer 22 sent by the relative positioning subsystem 16. The input provided by the relative positioning subsystem 16 is used subsequently as auxiliary information to increase processing accuracy after calibrating the initial coordinates. In Step 510, the tilt data (acquired in Step 508) is used to establish a second mathematic equation. In Step 512, using the two mathematical equations obtained in Step 504 and Step 510, real coordinates of the LED light source 20 can then be solved. The subsequent positioning process can be done in two different approaches. The first approach (Step 516) is to use only the acceleration, tilt, and rotation angle information of the Absolute Pointer 22 provided by the relative positioning subsystem 16 to solve for the position on the image display apparatus 30. The second approach (Step 514) is to use both the relative positioning subsystem 16 and the image capture device 2 to solve for the position on the image display apparatus 30. In the second approach (Step 514), the image capture device 2 is responsible for the detection of the LED light source 20 location, and the relative positioning subsystem 16 is responsible for detecting the depth (z-axis) offset only.

FIG. 4 is a diagram of the perspective projection of Step 506. In this step, point Q is captured by B (image capture device 2) and then the acquired image is mapped to point P on CCD 60. The parameter f is the focal length of the image capture device B, Aₓ is the horizontal distance between P and center of the CCD, W is the scaling factor between the CCD and the resolution, L_{z} is the distance between point Q and the image capture device B, and Lₓ is the horizontal distance between point Q and device B.

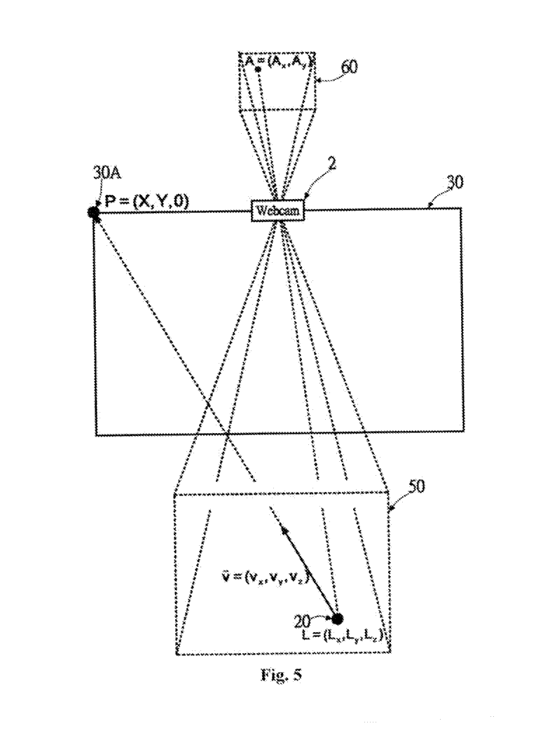

FIG. 5 is a sketch of the calibration step described in Step 508. When the light source 20 (Point L) is at a distance from the image display apparatus 30 (e.g., the distance plane 50), and the Absolute Pointer 22 is aimed at a specific spot (e.g., Point P (30A), the upper-left corner) on the image display apparatus 30, the image capture device 2 captures an image with the LED light source 20 in it and maps the light source to a point A on CCD 60. At this moment, the vector from Point L to Point P is parallel to Vector [symbol] , the axis of the tilt Absolute Pointer 22.

Combining Steps 504 and 508, we can construct the following equations:

Notation definitions (the underlined parts are known parameters):

P=(X, Y, 0): Calibration point

[symbol]

=(vₓ, v_{y}, v_{z}): Slope vector

L=(Lₓ, L_{y}, L_{z}) : Actual position of light spot

A=(Aₓ, A_{y}): Projected point on CCD

f: Webcam focal length

W: Scaling ratio between CCD and image resolution

By projection relationship:

$$\{ \begin{matrix}\frac{{L}_{x}}{{L}_{z}} = \frac{\frac{{A}_{x}}{W}}{f} \\ \frac{{L}_{y}}{{L}_{z}} = \frac{\frac{{A}_{y}}{W}}{f}\end{matrix} \frac{{L}_{x}}{{L}_{y}} = \frac{{A}_{x}}{{A}_{y}} \qquad ( 1 )$$

By calibration relationship:

$$〈 {L}_{x} - X , {L}_{y} - Y , {L}_{z} 〉 \vert \vert 〈 {v}_{x} , {v}_{y} , {v}_{z} 〉 \frac{{L}_{x} - X}{{v}_{x}} = \frac{{L}_{y} - Y}{{v}_{y}} = \frac{{L}_{z}}{{v}_{z}} {}^{From ( 1 )} \frac{\frac{{A}_{x}}{{A}_{y}} {L}_{y} - X}{{v}_{x}} = \frac{{L}_{y} - Y}{{v}_{y}} = \frac{{L}_{z}}{{v}_{z}} \{ \begin{matrix}Y + \frac{{L}_{z}}{{v}_{z}} {v}_{y} = {L}_{y} \\ \frac{{A}_{y}}{{A}_{x}} ( X + \frac{{L}_{z}}{{v}_{z}} {v}_{x} ) = {L}_{y}\end{matrix} \qquad ( 2 )$$

Combine the above two equations in (2) by L_{y}, then

$$Y + \frac{{L}_{z}}{{v}_{z}} {v}_{y} = \frac{{A}_{y}}{{A}_{x}} ( X + \frac{{L}_{z}}{{v}_{z}} {v}_{x} ) = \frac{{A}_{y}}{{A}_{x}} X + \frac{{A}_{y}}{{A}_{x}} \frac{{L}_{z}}{{v}_{z}} {v}_{x} \\ \frac{{L}_{z}}{{v}_{z}} {v}_{y} - \frac{{A}_{y}}{{A}_{x}} \frac{{L}_{z}}{{v}_{z}} {v}_{x} = \frac{{A}_{y}}{{A}_{x}} X - Y \\ {L}_{z} ( \frac{{v}_{y}}{{v}_{z}} - \frac{{A}_{y}}{{A}_{x}} \frac{{v}_{x}}{{v}_{z}} ) = \frac{{A}_{y}}{{A}_{x}} X - Y \\ {L}_{z} = ( \frac{{A}_{y} X - {A}_{x} Y}{{A}_{x} {v}_{y} - {A}_{y} {v}_{x}} ) {v}_{z} \qquad ( 3 )$$

The next questions are:
1. (Step 516) Given a motion vector [symbol] =(vₓ, v_{y}, v_{z}) and a projection point A=(Aₓ, A_{y}) only, how to find the screen coordinates P′=(X, Y, 0)?
2. (Step 514) Given a motion vector [symbol] =(vₓ, v_{y}, v_{z}), calibration location L=(Lₓ, L_{y}, L_{z}) and moving direction [symbol] =(tₓ, t_{y}, t_{z}) (e.g., acquired by g-sensor), how to find the screen coordinates P′=(X, Y, 0)?

### Solution of Question 1

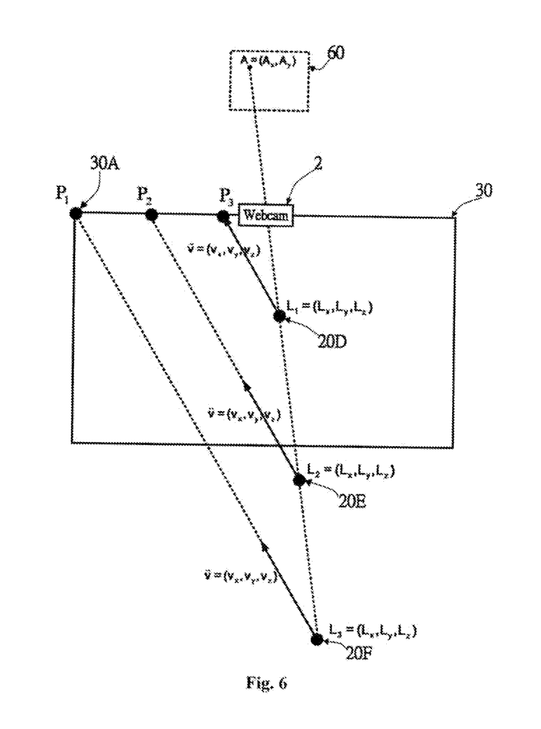

First, we notice that the solution is NOT unique (FIG. 6)!

FIG. 6 shows that given a motion vector [symbol] =(vₓ, v_{y}, v_{z}) and a projection point A=(Aₓ, A_{y}) only, there could be an infinite number of solutions P. As shown, when the light source 20 of the Absolute Pointer 22 is at different distances from the image display apparatus 30 (e.g., Point L₁ 20D, Point L₂ 20E, and Point L₃ 20F) but projected to the same point (e.g., Point A) in perspective projection on CCD 60, the same tilt vector [symbol] will result at different positions on the image display apparatus 30 (e.g., Points P₁, P₂, and P₃).

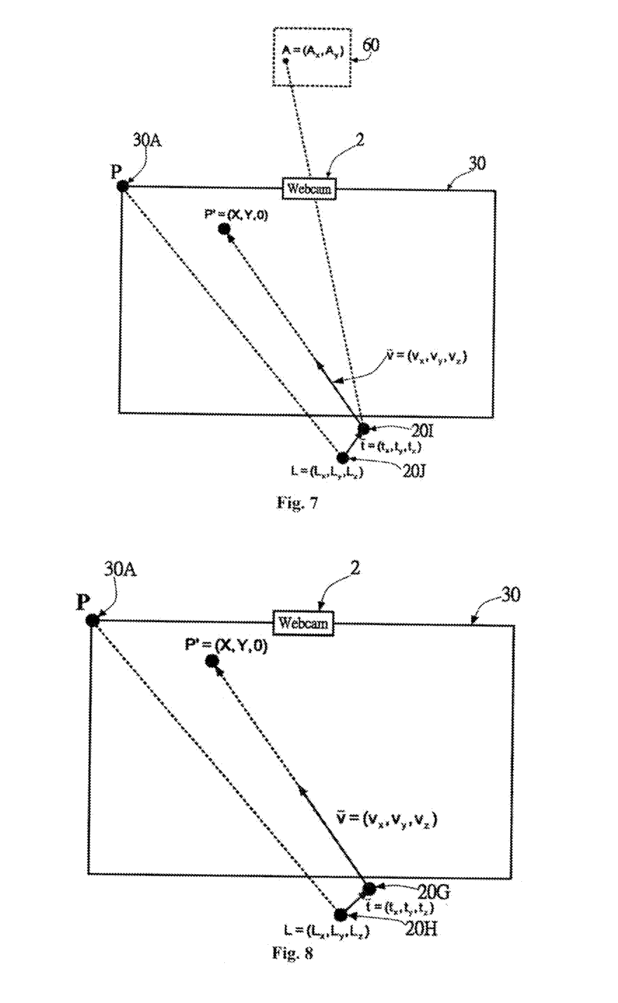

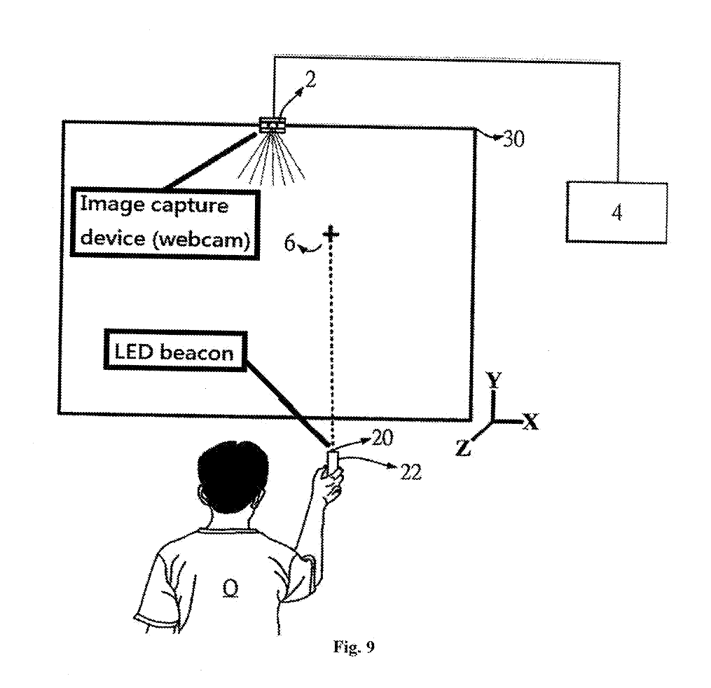

However, if we start at calibration location L=(Lₓ, L_{y}, L_{z}) (20J) and record the moving direction [symbol] =(tₓ, t_{y}, t_{z}) (FIG. 7), then from equation (2) we have

$$\{ \begin{matrix}Y + \frac{{L}_{z} + {t}_{z}}{{v}_{z}} = {L}_{y} \\ \frac{{A}_{y}}{{A}_{x}} ( X + \frac{{L}_{z} + {t}_{z}}{{v}_{z}} {v}_{x} ) = {L}_{y}\end{matrix} \\ \{ \begin{matrix}\frac{Y}{{L}_{z} + {t}_{z}} + \frac{{v}_{y}}{{v}_{z}} = \frac{{L}_{y}}{{L}_{z} + {t}_{z}} \\ \frac{{A}_{y}}{{A}_{x}} ( \frac{X}{{L}_{z} + {t}_{z}} + \frac{{v}_{x}}{{v}_{z}} ) = \frac{{L}_{y}}{{L}_{z} + {t}_{z}}\end{matrix} {}^{From ( 1 )} \{ \begin{matrix}\frac{Y}{{L}_{z} + {t}_{z}} + \frac{{v}_{y}}{{v}_{z}} = \frac{{A}_{y} / W}{f} \\ \frac{{A}_{y}}{{A}_{x}} ( \frac{X}{{L}_{z} + {t}_{z}} + \frac{{v}_{x}}{{v}_{z}} ) = \frac{{A}_{y} / W}{f}\end{matrix} \\ \{ \begin{matrix}Y = ( {L}_{z} + {t}_{z} ) ( \frac{{A}_{y} / W}{f} - \frac{{v}_{y}}{{v}_{z}} ) \\ X = ( {L}_{z} + {t}_{z} ) ( \frac{{A}_{x} / W}{f} - \frac{{v}_{x}}{{v}_{z}} )\end{matrix}$$

Therefore, if the light source is moved from position 20J to another position (e.g. such as 20I), then it only needs to start with the calibrated 3D coordinates L=(Lₓ, L_{y}, L_{z}) and keeps recording the moving direction (using the relative positioning subsystem 16) to get the displacement vector t_{z}. Thereafter, using t_{z} in conjunction with the given ≈=(vₓ, v_{y}, v_{z}) and A=(Aₓ, A_{y}), the computer 4 can solve the new position P′ on the image display apparatus 30 pointed by the Absolute Pointer 22.

### Solution of Question 2

When there is no image capture device 2 as an auxiliary tool, we then use the nine-axis relative positioning subsystem 16 for direct calculation. If the front light source is moved from position 20H to another position (e.g. such as 20G in FIG. 8), then we start with the calibrated 3D coordinates L=(Lₓ, L_{y}, L_{z}) and keeps recording the moving direction (using the relative positioning subsystem 16) to get the moving vector [symbol] =(tₓ, t_{y}, t_{z}). Then, with the given [symbol] =(vₓ, v_{y}, v_{z}), the computer 4 can solve the new position P′ on the image display apparatus 30 pointed by the Absolute Pointer 22.

We can use FIG. 8 to depict the phenomenon. Since

$$\frac{( {L}_{x} + {t}_{x} ) - X}{{v}_{x}} = \frac{( {L}_{y} + {t}_{y} ) - Y}{{v}_{y}} = \frac{( {L}_{z} + {t}_{z} )}{{v}_{z}} , we have$$

$$\underline{\{ \begin{matrix}X = ( {L}_{x} + {t}_{x} ) - \frac{( {L}_{z} + {t}_{z} ) {v}_{x}}{{v}_{z}} \\ Y = ( {L}_{y} + {t}_{y} ) - \frac{( {L}_{z} + {t}_{z} ) {v}_{z}}{{v}_{z}}\end{matrix}}$$

1. A computing system for direct three-dimensional pointing and command input, comprising:
at least one computing device having at least one processor, at least one memory, and at least one graphical user interface;
a pointing/input device including at least one light source and a relative positioning module providing information regarding at least a displacement of the pointing/input device from a first position to a next position in a three-dimensional space and an axis direction vector of the pointing/input device with respect to the at least one graphical user interface;
at least one imaging device operably linked to the computing device processor and configured for capturing a plurality of image frames each including a view of the at least one light source as the pointing/input device is held and/or moved from the first position to the next position and within a field of view of the at least one imaging device; and
at least one non-transitory computer program product operable on the computing device processor and including executable instructions for calculating at least a position and/or a motion of the at least one light source and for displaying the at least a position and/or a motion of the at least one light source in the graphical user interface as a visible marker.

2. The system of claim 1, wherein the at least one computer program product includes executable instructions for determining a position of the at least one light source in each of the plurality of sequential image frames.

3. The system of claim 2, wherein the at least one computer program product includes executable instructions for calculating an x-coordinate, a y-coordinate, and a z-coordinate of the at least one light source in each of the plurality of sequential image frames.

4-6. (canceled)

7. The system of claim 3, wherein the at least one computer program product further includes executable instructions for determining a calibration point on the at least one graphical user interface.

8. The system of claim 7, wherein the at least one computer program product includes executable instructions for calculating the x-coordinate, the y-coordinate, and the z-coordinate from the relative positioning module information and the determined calibration point.

9. The system of claim 3, wherein the at least one computer program product further includes executable instructions for calculating a distance between the pointing/input device and the at least one graphical user interface.

10. The system of claim 9, wherein the at least one computer program product calculates a distance between the pointing/input device and the at least one graphical user interface by a tilt vector provided by the pointing/input device relative positioning module.

11. The system of claim 10, wherein the at least one computer program product includes executable instructions for calculating the x- coordinate, the y- coordinate, and the z-coordinate of the visible marker in the each of the plurality of sequential image frames from the determined position of the at least one light source in the each of the plurality of sequential image frames and the determined distance between the pointing/input device and the at least one graphical user interface.

12. In a computing system environment, a method for direct three-dimensional pointing and command input, comprising:
providing a pointing/input device including at least one light source and a relative positioning module providing information regarding at least a displacement of the pointing/input device from a first position to a next position in a three-dimensional space and a distance between the pointing/input device and at least one graphical user interface operably connected to at least one computing device having at least one processor and at least one memory;
holding and/or moving the pointing/input device in a three-dimensional space disposed within a field of view of at least one imaging device operably connected to the computing device;
by the at least one imaging device, capturing a plurality of sequential image frames each including a view of a position of the at least one light source within the imaging device field of view;
by at least one computer program product operable on the at least one processor, calculating at least a position and/or a motion of the at least one light source and displaying the at least a position and/or a motion of the at least one light source in a graphical user interface operably connected to the computing device.

13. The method of claim 12, further including, by executable instructions of the at least one computer program product, determining a position of the at least one light source in each of the plurality of sequential image frames.

14. The method of claim 13 further including, by executable instructions of the at least one computer program product, calculating an x-coordinate, a y-coordinate, and a z-coordinate of the at least one light source in each of the plurality of sequential image frames.

15. The method of claim 14, further including determining a calibration point on the at least one graphical user interface.

16. The method of claim 15, further including, by executable instructions of the at least one computer program product, calculating the x-coordinate, the y-coordinate, and the z-coordinate from the relative positioning module information and the determined calibration point.

17. The method of claim 14, further including, by executable instructions of the at least one computer program product, calculating a distance between the pointing/input device and the at least one graphical user interface.

18. The method of claim 17, further including, by executable instructions of the at least one computer program product, calculating a distance between the pointing/input device and the at least one graphical user interface by a tilt vector provided by the pointing/input device relative positioning module.

19. The method of claim 18, further including, by executable instructions of the at least one computer program product, calculating the x-coordinate, the y-coordinate, and the z-coordinate of the visible marker in the each of the plurality of sequential image frames from the determined position of the at least one light source in the each of the plurality of sequential image frames and the determined distance between the pointing/input device and the at least one graphical user interface.
